(19) United States
(12) Patent Application Publication
(10) Pub. No.: US 2004/0228054 A1
(43) Pub. Date: Nov. 18, 2004

(54) Fault detecting circuit

(75) Inventor: Masaaki Shiotani, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 10/704,762

(22) Filed: Nov. 12, 2003

(30) Foreign Application Priority Data
May 14, 2003 (JP) 2003-135448

(51) Int. Cl. H02H 9/04

(52) U.S. Cl. 361/91.1

(57) ABSTRACT

The fault detecting circuit can precisely detect an abnormal condition of a system. When the abnormal condition occurs, a power supply current flowing through the system is increased. Accordingly, a collector current flowing through an NPN transistor is increased, and a collector voltage is decreased. When the collector voltage falls below or equal to a reference voltage, an output signal from a voltage comparator is turned to an “L” level. The output signal is supplied to a reset terminal of the system as a reset signal so as to restart the system from an initial condition.

### BACKGROUND OF THE INVENTION

1) Field of the Invention

The present invention relates to a fault detecting circuit for detecting an abnormal condition of a system so as to ensure a normal operation.

2) Description of the Related Art

In order to detect an abnormal condition of a system including an IC (Integrated Circuit) device, a watch dog timer has been hitherto used.

The watch dog time is formed by combining a counter which counts pulse signals, e.g., clock signals, continuously supplied at constant periods and outputs an interrupt signal when such counted value reaches a predetermined value, and a program included in the system so as to periodically output reset signals to the counter.

According to the watch dog timer under a normal operating condition of the system, the reset signals are periodically output by the program in order to reset the counter before the counted value reaches the predetermined value. When a runaway in the program, i.e., an improper operation, occurs due to an abnormal condition in the system, the program stops outputting the reset signals, which results in continuous increase of the counted value of the counter until the value reaches the predetermined value. Accordingly, the counter supplies the interrupt signal in order to carry out tasks such as a restoration of the system to an initial condition.

The conventional watch dog timer has, however, the following problem.

In order to periodically reset the watch dog timer, the watch dog timer may be, for example, configured with a program such as a timer for periodically generating interrupt handling. When the interrupt handling program operates normally without any abnormality, an abnormal condition may not be detected by the watch dog timer even though the abnormal operations occur in programs other than the interrupt handling program. Therefore, provision of only one watch dog timer is not enough for perfect detection of the abnormal condition of the system.

### SUMMARY OF THE INVENTION

An object of the present invention is to provide a fault detecting circuit for precisely detecting an abnormal condition of the system in place of or in addition to a watch dog timer.

According to a first aspect of the present invention, there is provided a fault detecting circuit including a resistance provided within a power supply line of a monitored system for generating a detecting voltage depending on a power supply current flowing through the system, and a transistor for amplifying the detecting voltage to obtain a reset signal and outputting the reset signal to the system.

The detecting voltage is generated depending on the power supply current flowing through the system by means of the resistance provided within the power supply line of the monitored system. The detecting voltage is amplified by the transistor and the amplified signal is output as the reset signal to the monitored system. Accordingly, an abnormal condition of the system can be monitored based on an excess current due to a problem such as an abnormal condition in a circuit.

According to a second aspect of the present invention, there is provided a fault detecting circuit including a resistance provided within a power supply line of a monitored system for generating a detecting voltage depending on a power supply current flowing through the system, a transistor for amplifying the detecting voltage to generate an output voltage, and at least one voltage comparator for comparing the output voltage with a reference voltage so as to output a reset signal to the system when the output voltage exceeds the reference voltage.

The detecting voltage is generated depending on the power supply current flowing through the system by means of the resistance provided within the power supply line of the monitored system. The detecting voltage is amplified by the transistor and the amplified output voltage is supplied to the at least one voltage comparator. The at least one voltage comparator compares the output voltage with the reference voltage so as to output the reset signal to the monitored system when the output voltage exceeds the reference voltage. Accordingly, the system can be monitored by precise detection of an excess current due to a problem such as an abnormal condition in a circuit.

The at least one voltage comparator may compare the output voltage with a plurality of reference voltages, and outputs a reset signal corresponding to the reference voltage concerned, which is exceeded by the output voltage, in order to restore the system. Accordingly, an excess current due to a problem such as an abnormal condition in a circuit can be precisely detected so as to suitably carry out a treatment depending on a magnitude of the excess current.

### BRIEF DESCRIPTION OF THE DRAWINGS

FIG. 1A is a circuit diagram of a fault detecting circuit according to a first embodiment of the present invention;

FIG. 1B is a signal wave form chart of the fault detecting circuit shown in FIG. 1A; and

FIG. 2 is a circuit diagram of a fault detecting circuit according to a second embodiment of the present invention.

### DETAILED DESCRIPTION OF THE INVENTION

### FIRST EMBODIMENT

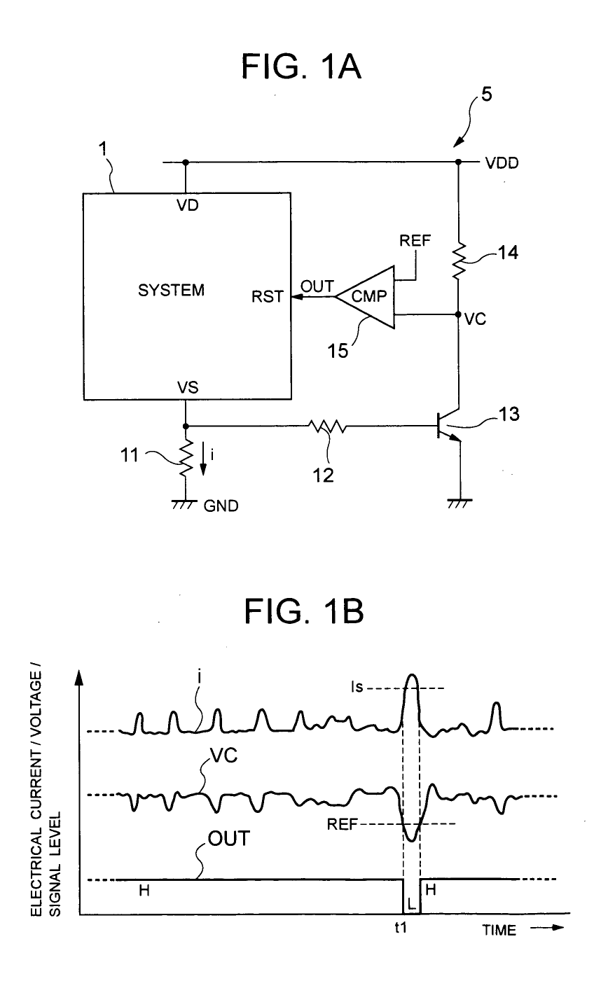

Referring to FIGS. 1A and 1B, a fault detecting circuit 5 according to a first embodiment of the present invention will be described.

The fault detecting circuit 5 monitors a power supply current i flowing through an object to be monitored, i.e., the system 1. When the power supply current i exceeds a predetermined set value Is, the fault detecting circuit determines that the system 1 is in an abnormal condition.

As shown in FIG. 1A, a power supply terminal VD of the system 1 is connected to a power supply potential VDD, and a grounding terminal VS of the system 1 is connected to a ground potential GND via a resistance 11. Furthermore, the grounding terminal VS of the system 1 is connected to a base of an NPN transistor 13 via a resistance 12.

An emitter of the NPN transistor 13 is connected to the ground potential GND, and a collector of the NPN transistor 13 is connected to the power supply potential VDD via a resistance 14. Furthermore, the collector of the NPN transistor 13 is connected to a comparison terminal of a voltage comparator (CMP) 15. A reference voltage REF is applied to a reference terminal of the voltage comparator 15 from a reference voltage generator (not shown).

When a collector voltage VC of the NPN transistor 13 applied to the comparison terminal is less than the reference voltage REF applied to the reference terminal, the voltage comparator 15 turns an output signal OUT to an “L” level. When the collector voltage VC is more than the reference voltage REF, the voltage comparator 15 turns the output signal OUT to an “H” level. The output signal OUT from the voltage comparator 15 is supplied to a reset terminal RST of the system 1.

It should be noted that the resistances 11, 12 and 14 are set in such a manner that the collector voltage VC of the NPN transistor 13 is equal to the reference voltage REF, when the power supply current i of the system 1 flowing through the resistance 11 is equal to the set value Is.

Next, an operation of the circuit shown in FIG. 1A will be described with reference to the FIG. 1B.

Most of the power supply current i flowing through the system 1 is discharged to the ground potential GND via the resistance 11. Accordingly, a voltage proportional to the power supply current i is generated across the resistance 11, and thus a potential at the grounding terminal VS of the system 1 is higher than the ground potential GND.

Since the grounding terminal VS of the system 1 is connected to the base of the NPN transistor 13 via the resistance 12, a base current determined by the potential at the grounding terminal VS flows through the NPN transistor 13. Accordingly, a collector current is supplied to the collector of the NPN transistor 13 from the power supply potential VDD via the resistance 14, and thus the collector voltage VC is generated in accordance with the collector current. The collector voltage VC is applied to the comparison terminal of the voltage comparator 15 so as to be compared with the reference voltage REF applied to the reference terminal of the voltage comparator 15.

Under the normal operating condition of the system 1, the power supply current i flowing through the system 1 is lower than the set value Is. Accordingly, the collector current of the NPN transistor 13 is small, and thus a voltage drop across the resistance 14 is small. Consequently, the collector voltage VC is higher than the reference voltage REF, and thus the output signal OUT from the voltage comparator 15 is turned to the “H” level. Therefore, no reset signal is generated for the system 1, and thus the system 1 continues the designated operation.

When the system 1 malfunctions due to inclusion of a noise such as a spike noise in the power supply potential VDD, a problem such as a latch up is generated. Consequently, an abnormal current flows through the system, which results in an increase of the power supply current i. Accordingly, the potential at the grounding terminal VS of the system 1 is increased, and thus the base current and the collector current of the NPN transistor 13 are both increased. Due to an increase of the collector current, the voltage drop across the resistance 14 is increased, which results in a decrease of the collector voltage VC.

When the power supply current i flowing through the system 1 exceeds the set value Is, the collector voltage VC is decreased below the reference voltage REF. Accordingly, the output signal OUT from the voltage comparator 15 is turned to the “L” level, and thus the reset signal is supplied to the reset terminal RST of the system 1.

All circuits of the system 1 are forcibly returned to initial conditions by the input of the reset signal. When the abnormal current disappears owing to an elimination of the latch up by the reset operation, the power supply current i flowing through the system 1 is decreased below the set value Is. Accordingly, the output signal OUT from the voltage comparator 15 is returned to the “H” level, and thus the system 1 is restarted from an initial condition.

As described above, the fault detecting circuit 5 according to the first embodiment monitors the power supply current i flowing through the system 1, so as to output the output signal OUT for resetting the system 1 when the power supply current i exceeds the set value Is. This allows an accurate detection of the abnormal conditions of the system by way of the power supply current i. Accordingly, continuous flow of an excess current through the system can be avoided, thereby protecting the system from the problems such as thermal damage.

### SECOND EMBODIMENT

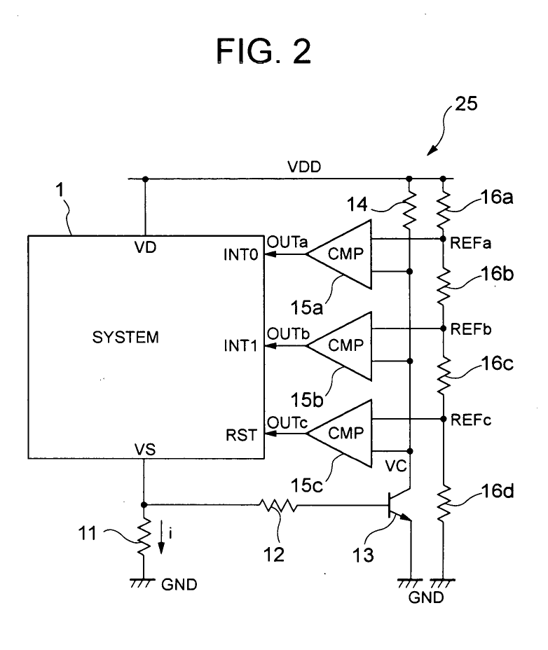

FIG. 2 is a circuit diagram of a fault detecting circuit 25 according to a second embodiment of the present invention. The same reference numerals as those used in FIGS. 1A and 1B are assigned for elements in FIG. 2 when the elements are the same with those in FIGS. 1A and 1B.

The fault detecting circuit 25 monitors a power supply current i flowing through an object to be monitored, i.e., the system 1, and then outputs various fault detecting signals depending on levels of the power supply current i.

A power supply terminal VD of the system 1 is connected to a power supply potential VDD, and a grounding terminal VS of the system 1 is connected to a ground potential GND via a resistance 11. Furthermore, the grounding terminal VS of the system 1 is connected to a base of an NPN transistor 13 via a resistance 12.

An emitter of the NPN transistor 13 is connected to the ground potential GND, and a collector of the NPN transistor 13 is connected to the power supply potential VDD via a resistance 14. Furthermore, the collector of the NPN transistor 13 is commonly connected to comparison terminals of voltage comparators 15a, 15b and 15c. Reference voltages REFa, REFb and REFc are respectively applied to reference terminals of the voltage comparators 15a-15c. The reference voltages REFa, REFb and REFc are obtained by distributing the power supply potential VDD using resistances 16a, 16b, 16c and 16d such that voltage levels of the reference voltages REFa, REFb and REFc decrease in the described order.

When the reference voltage REFa (or REFb or REFc) applied to the reference terminal of the voltage comparator 15a (or 15b or 15c) exceeds the collector voltage VC of the NPN transistor 13 applied to the comparison terminal of the voltage comparator 15a (or 15b or 15c), the voltage comparator turns the output signal OUTa (or OUTb or OUTc) to an “L” level. On the other hand, when the reference voltage REFa (or REFb or REFc) applied to the voltage comparator 15a (or 15b or 15c) falls below the collector voltage VC, the voltage comparator turns the output signal OUTa (or OUTb or OUTc) to an “H” level.

The output signal OUTa from the voltage comparator 15a is supplied to an interrupt terminal UNTO of the system 1, the output signal OUTb from the voltage comparator 15b is supplied to an interrupt terminal UNT1 of the system 1, and the output signal OUTc from the voltage comparator 15c is supplied to a reset terminal RST of the system 1.

It should be noted that resistance values of the resistances 11, 12 and 14 are set in such a manner that the collector voltage VC of the NPN transistor 13 is more than the reference voltage REFa, when the power supply current i of the system 1 flowing through the resistance 11 is within a normal operating range. Furthermore, the reference voltage REFc is set in such a manner that the reference voltage REFc is equal to the collector voltage VC generated at the collector of the NPN transistor 13, when an abnormal fault current If necessitating the restart of the system 1 flows.

Next, an operation of the circuit will be described.

When the power supply current i of the system 1 is within the normal operation range, the collector voltage VC of the NPN transistor 13 is higher than the reference voltage REFa. Accordingly, the output signals OUTa-OUTc from the voltage comparators 15a-15c are all turned to the “H” levels. Therefore, neither interrupt signal nor reset signal is generated, and thus the system 1 continues the designated operation.

When the power supply current i flowing through the system 1 exceeds the normal operating range such that the collector voltage VC of the NPN transistor 13 is between the reference voltage REFa and the reference voltage REFb, the output signal OUTa from the voltage comparator 15a is turned to the “L” level. In this instance, the output signals OUTb and OUTc from the voltage comparators 15b and 15c are both turned to the “H” levels. Accordingly, an interrupt signal is generated to the interrupt terminal INTO of the system 1 so as to forcibly terminate an operation of the system 1 such as an active task at the time of the termination.

When the power supply current i flowing through the system 1 further increases such that the collector voltage VC of the NPN transistor 13 is between the reference voltage REFb and the reference voltage REFc, the output signals OUTa and OUTb from the voltage comparators 15a and 15b are both turned to the “L” levels. In this instance, the output signal OUTc from the voltage comparator 15c is turned to the “H” level. Accordingly, interrupt signals are generated to the interrupt terminals INT0 and INT1 of the system 1 so as to forcibly terminate an operation of the system 1 such as an active job at the time of the termination.

When the power supply current i flowing through the system 1 exceeds the predetermined fault current If, the collector voltage VC of the NPN transistor 13 falls below or equal to the reference voltage REFc. Accordingly, the output signals OUTa-OUTc from the voltage comparators 15a-15c are all turned to the “L” levels. Consequently, a reset signal is generated to the reset terminal RST of the system 1 so as to forcibly return all circuits within the system 1 to initial conditions.

When the abnormal current disappears by a reset operation, the power supply current i flowing through the system 1 has a normal value. Accordingly, the output signals OUTa-OUTc from the voltage comparators 15a-15c are all returned to the “H” levels, and thus the system 1 is restarted from an initial condition.

As described above, the fault detecting circuit 25 according to the second embodiment is configured to output detecting signals, i.e., output signals, having plural levels depending on the magnitude of the power supply current i flowing through the system 1. Accurate abnormality detection of the system is achieved by differentiation of the abnormal condition in several levels depending on the magnitude of the power supply current i. Accordingly, appropriate treatment can be taken which suits a type of fault in the system, and continuous flowing of an excess current through the system can be avoided, thereby protecting the system from the problems such as thermal damage.

The fault detecting circuit 25 can be mounted, for example, on a vehicle. In this instance, the system 1 to be monitored by the circuit 25 performs a steering control, a spark plug control of an engine, and a gear control. The outputs of the voltage comparators 15a-15c are respectively connected to the interrupt terminals corresponding to the steering control, the spark plug control of the engine, and the gear control. Thus, even though one of the controls is forcibly terminated, the other controls can maintain their operations. Accordingly, this embodiment is preferable for a system which requires a continuous control such as a vehicle.

It should be noted that the present invention is not limited to the above embodiments, and thus various changes and modifications can be made. Such modifications will be exemplified as follows:

Although the resistance 11 is provided between the grounding terminal VS of the system 1 and the ground potential GND so as to monitor the power supply current i flowing through the system 1 by the voltage generated across the resistance 11 in the illustrated embodiments, the resistance may be provided between the power supply terminal VD of the system 1 and the power supply potential VDD so as to monitor a voltage generated across the resistance.

Although the collector voltage VC of the NPN transistor 13 is compared with the reference voltage REF, and the output signal OUT resulting from the comparison is supplied to the reset terminal RST of the system 1 in the illustrated embodiments, the voltage comparator 15 may be omitted if the resistances 11, 12 and 14 are set in such a manner that the collector voltage VC is equal to a voltage corresponding to the “L” level when the power supply current i becomes the set value Is.

Although the fault detecting circuit 25 in FIG. 2 detects the abnormal condition of the system 1 in three levels, the number of detection levels may be two or more than three, so as to suitably carry out a treatment depending on the type of the abnormal condition.

This application is based on a Japanese patent application No. 2003-135448 which is herein incorporated by reference.

What is claimed is:

1. A fault detecting circuit comprising:
a resistance provided within a power supply line of a monitored system for generating a detecting voltage depending on a power supply current flowing through the system; and
a transistor for amplifying the detecting voltage to obtain a reset signal and outputting the reset signal to the system.

2. The fault detecting circuit according to claim 1, wherein the resistance is provided between a grounding terminal of the system and a ground potential.

3. The fault detecting circuit according to claim 1, wherein the resistance is provided between a power supply terminal of the system and a power supply potential.

4. A fault detecting circuit comprising:
a resistance provided within a power supply line of a monitored system for generating a detecting voltage depending on a power supply current flowing through the system;
a transistor for amplifying the detecting voltage to generate an output voltage; and
at least one voltage comparator, each voltage comparator comparing the output voltage with at least one reference voltage supplied to the voltage comparator concerned, so as to output a reset signal corresponding to the reference voltage to the system when the output voltage exceeds the reference voltage.

5. The fault detecting circuit according to claim 4, wherein the resistance is provided between a grounding terminal of the system and a ground potential.

6. The fault detecting circuit according to claim 4, wherein the resistance is provided between a power supply terminal of the system and a power supply potential.

7. The fault detecting circuit according to claim 4, wherein the at least one reference voltage is a plurality of reference voltages.

8. The fault detecting circuit according to claim 7, wherein the at least one voltage comparator is a plurality of voltage comparators, and each voltage comparator compares the output voltage with the reference voltage of the voltage comparator, and outputs the reset signal from the voltage comparator when the reference voltage is exceeded by the output voltage in order to restore an corresponding fault in the system.

9. The fault detecting circuit according to claim 7, wherein the fault detecting circuit is used for the monitored system requiring continuous control.

10. The fault detecting circuit according to claim 9, wherein the fault detecting circuit is mounted on a vehicle for controlling the monitored system of the vehicle.

11. The fault detecting circuit according to claim 10, wherein the monitored system performs a steering control, a spark plug control of an engine, and a gear control.

12. A fault detecting circuit comprising:
first means provided within a power supply line of a monitored system for generating a detecting voltage depending on a power supply current flowing through the system; and
second means for amplifying the detecting voltage to obtain a reset signal and outputting the reset signal to the system.

13. The fault detecting circuit according to claim 12, wherein the first means is provided between a grounding terminal of the system and a ground potential.

14. The fault detecting circuit according to claim 12, wherein the first means is provided between a power supply terminal of the system and a power supply potential.
